(19) United States
(12) Patent Application Publication
(10) Pub. No.: US 2024/0107403 A1
(43) Pub. Date: Mar. 28, 2024

(54) TERMINAL CONTROL SYSTEM, TERMINAL CONTROL APPARATUS, AND TERMINAL CONTROL METHOD

(71) Applicant: NEC Corporation, Tokyo (JP)

(72) Inventors: Koya TAKATA, Tokyo (JP); Atsushi Kamoi, Tokyo (JP); Hisashi Mizumoto, Tokyo (JP); Masaki Aizono, Tokyo (JP)

(73) Assignee: NEC Corporation, Tokyo (JP)

(21) Appl. No.: 18/236,642

(22) Filed: Aug. 22, 2023

(30) Foreign Application Priority Data
Sep. 27, 2022 (JP) 2022-154026

(51) Int. Cl. H04W 36/08; H04B 10/11

(52) U.S. Cl. CPC H04W 36/08; H04B 10/11

(57) ABSTRACT

A terminal control system causes a wireless terminal to perform a switching process of switching a connection destination of the wireless terminal in accordance with the wireless terminal being located at such a position as to be capable of establishing connection both with a wireless base station and with a free-space optical communication apparatus, acquires weather information regarding an area in which the wireless terminal is located, and causes, in accordance with the weather information, the wireless terminal to stop the switching process of switching the connection destination of the wireless terminal from the wireless base station to the free-space optical communication apparatus.

### CROSS REFERENCE TO RELATED APPLICATIONS

This application is based upon and claims the benefit of priority from Japanese Patent Application No. 2022-154026 filed on Sep. 27, 2022, the disclosure of which is incorporated herein in its entirety by reference.

### TECHNICAL FIELD

The present invention relates to a terminal control system, a terminal control apparatus, and a terminal control method.

### BACKGROUND ART

Patent Literature 1 discloses a communication link system including an RF portion and a laser portion. Patent Literature 1 discloses adjusting, based on environmental information or transmit and receive strengths, data to be transmitted through the RF portion and the laser portion.

### CITATION LIST

### Patent Literature

[Patent Literature 1]

Japanese Translation of PCT International Application, Tokuhyo, No. 2005-506718

### SUMMARY OF INVENTION

### Technical Problem

The inventors of the present invention are considering using free-space optical communication technique to complement wireless communication such as local 5G communication, on the basis of their unique idea. By disposing a free-space optical communication apparatus in a place in which the status of connection with a base station is poor, such as, for example, the peripheral part of an service area, and switching connection destinations according to a communication rate or communication quality when a wireless terminal is located at such a position as to be capable of establishing connection both with a wireless base station and with the free-space optical communication apparatus, it is possible to provide a preferred communication environment.

However, the communication rate, communication quality, etc. of free-space optical communication can significantly vary under the influence of weather changes due to rain, snow, fog, and the like. Thus, in a case of the configuration in which connection destinations are switched according to a communication rate or communication quality when a wireless terminal is located at such a position as to be capable of establishing connection both with a wireless base station and with a free-space optical communication apparatus, the switching of connection destinations of the wireless terminal occurs frequently under the influence of weather changes. This could cause a user to experience discomfort.

An example object of the present invention is to provide a terminal control system, a terminal control apparatus, and a terminal control method that are capable of preventing frequent switching of connection destinations of a wireless terminal under the influence of weather changes.

### Solution to Problem

An example aspect of a terminal control system of the present invention includes at least one processor, the at least one processor carrying out: a connection control process of causing a wireless terminal to perform a switching process of switching a connection destination of the wireless terminal between a wireless base station and a free-space optical communication apparatus, in response to the wireless terminal being located at such a position as to be capable of establishing connection both with the wireless base station and with the free-space optical communication apparatus; a weather information acquisition process of acquiring weather information regarding an area in which the wireless terminal is located; and a switching stop process of causing the wireless terminal to stop, in accordance with the weather information, the switching process of switching the connection destination of the wireless terminal from the wireless base station to the free-space optical communication apparatus.

An example aspect of a terminal control apparatus of the present invention includes at least one processor, the at least one processor carrying out: a connection control process of causing a wireless terminal to perform a switching process of switching a connection destination of the wireless terminal between a wireless base station and a free-space optical communication apparatus, in response to the wireless terminal being located at such a position as to be capable of establishing connection both with the wireless base station and with the free-space optical communication apparatus; a weather information acquisition process of acquiring weather information regarding an area in which the wireless terminal is located; and a switching stop process of causing the wireless terminal to stop, in accordance with the weather information, the switching process of switching the connection destination of the wireless terminal from the wireless base station to the free-space optical communication apparatus.

An example aspect of a terminal control method of the present invention includes: causing a wireless terminal to perform a switching process of switching a connection destination of the wireless terminal between a wireless base station and a free-space optical communication apparatus, in response to the wireless terminal being located at such a position as to be capable of establishing connection both with the wireless base station and with the free-space optical communication apparatus; acquiring weather information regarding an area in which the wireless terminal is located; and causing the wireless terminal to stop, in accordance with the weather information, the switching process of switching the connection destination of the wireless terminal from the wireless base station to the free-space optical communication apparatus.

### Advantageous Effects of Invention

An example object of the present invention is to provide a terminal control system, a terminal control apparatus, and a terminal control method that are capable of preventing frequent switching of connection destinations of a wireless terminal under the influence of weather changes.

### BRIEF DESCRIPTION OF DRAWINGS

FIG. 1 is a block diagram of an example configuration of a terminal control system in accordance with a first example embodiment.

FIG. 2 is a flowchart of an example operation of the terminal control system in accordance with the first example embodiment.

FIG. 3 is a block diagram of an example configuration of a terminal control apparatus in accordance with the first example embodiment.

FIG. 4 is a block diagram of an example configuration of a terminal control system in accordance with a second example embodiment.

FIG. 5 is a block diagram of an example configuration of a terminal control system in accordance with a third example embodiment.

FIG. 6 is a block diagram of an example configuration of a terminal control system in accordance with a variation of the third example embodiment.

FIG. 7 is a block diagram of an example configuration of a terminal control system in accordance with a fourth example embodiment.

FIG. 8 is a schematic diagram of a configuration of hardware of a computer in accordance with the example embodiments.

### EXAMPLE EMBODIMENTS

### First Example Embodiment

### (Terminal Control System)

The following description will discuss a terminal control system 100 in accordance with a first example embodiment of the present invention with reference to the drawings. The terminal control system 100 is a system that controls wireless communication and free-space optical communication. Wireless communication is the communication that is carried out with use of radio waves propagating through space. Free-space optical communication is the communication that is carried out with use of light propagating through space. Examples of the radio waves used in the wireless communication can encompass a microwave and a millimeter wave. Examples of the light used in the free-space optical communication can encompass a millimeter wave, a submillimeter wave, infrared light, visible light, and ultraviolet light. The scheme to carry out the wireless communication is not particularly limited, but may be a cellular communication scheme such as, for example, LTE or 5G. Note that the present example embodiment has a particularly remarkable example advantage in a case where 5G communication, the coverage area of which is relatively small, is used as the wireless communication scheme.

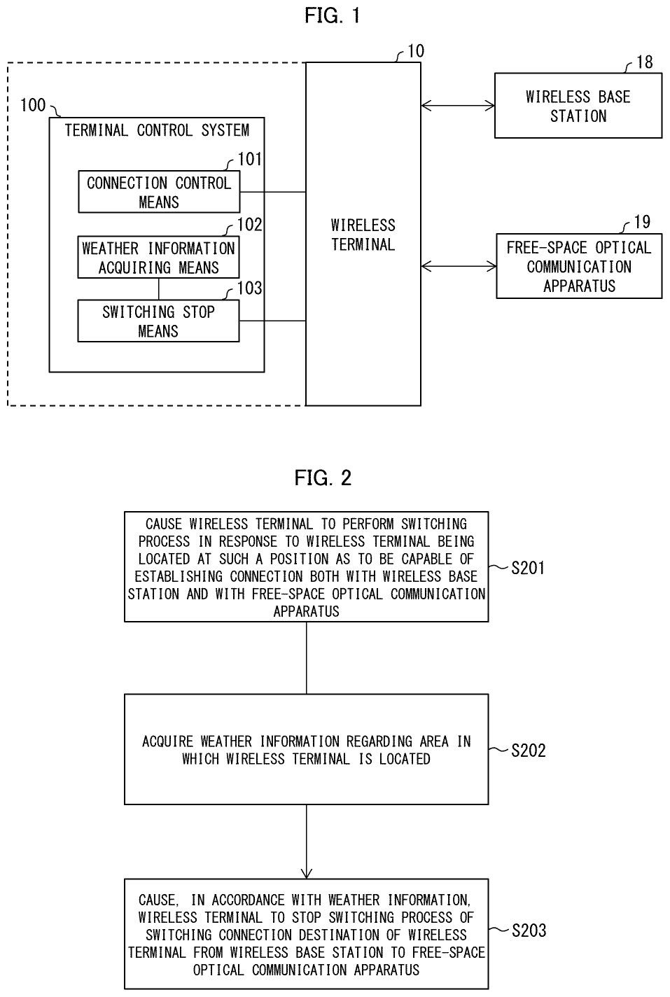

FIG. 1 is a functional block diagram of an example configuration of the terminal control system 100 in accordance with the first example embodiment of the present invention. In FIG. 1, each of the blocks indicates a function-by-function component. Accordingly, the blocks illustrated in FIG. 1 may be implemented in a single apparatus, or may be implemented in more than one apparatus. Further, some or all of the blocks may be implemented as functions with use of the cloud or the like. The terminal control system 100 includes a connection control means 101, a weather information acquiring means 102, and a switching stop means 103.

The terminal control system 100 controls a wireless terminal 10. The terminal control system 10 may be such that whole or part thereof communicates with the wireless terminal 10, or may be such that whole or part thereof is included in the terminal control system 100. Thus, the wireless terminal 10 may include one or more of the connection control means 101, the weather information acquiring means 102, and the switching stop means 103, may include all of the connection control means 101, the weather information acquiring means 102, and the switching stop means 103, or may include none of the connection control means 101, the weather information acquiring means 102, and the switching stop means 103.

The wireless terminal 10 is capable of establishing connection with a wireless base station 18 and with a free-space optical communication apparatus 19, and establishes connection with the wireless base station 18 and with the free-space optical communication apparatus 19 to carry out communication. Therefore, in the present specification, a wireless terminal being connected to a specific target refers to the wireless terminal being in data communication through a specific terminal. Further, the connection destination of a wireless terminal refers to through which apparatus the wireless terminal carries out data communication.

For example, the wireless terminal 10 being in data communication through the wireless base station 18 can be referred to as “the wireless terminal 10 is connected to the wireless base station 18” or “the connection destination of the wireless terminal 10 is the wireless base station 18”. In addition, the wireless terminal 10 being in data communication through the free-space optical communication apparatus 19 refers to “the wireless terminal 10 is connected to the free-space optical communication apparatus 19” or “the connection destination of the wireless terminal 10 is the free-space optical communication apparatus 19”.

In other words, the wireless terminal 10 is capable of carrying out data communication via wireless communication or free-space optical communication. Note that the wireless terminal 10 being in data communication via wireless communication encompasses, in addition to the case where the wireless terminal 10 is connected to the wireless base station 18, a case where the wireless terminal 10 is connected to another wireless communication apparatus.

The connection control means 101 causes the wireless terminal 10 to perform a switching process, in response to the wireless terminal 10 being capable of both data communication via wireless communication and data communication via free-space optical communication (e.g., in response to the wireless terminal 10 being located in such a position as to be capable of establishing connection both with the wireless base station 18 and with the free-space optical communication apparatus 19). The switching process is a process of switching between data communication via wireless communication and data communication via free-space optical communication. For example, the switching process may be a process of switching the connection destination of the wireless terminal 10 between the wireless base station 18 and the free-space optical communication apparatus 19, or may be a process of switching the connection destination of the wireless terminal 10 between the free-space optical communication apparatus 19 and another wireless communication apparatus.

In order for the wireless terminal 10 to be connected to the wireless base station 18, the distance between the wireless terminal 10 and the wireless base station 18 needs to be within a predetermined range. Similarly, in order for the wireless terminal 10 to be connected to the free-space optical communication apparatus 19, the distance between the wireless terminal 10 and the free-space optical communication apparatus 19 needs to be within a predetermined range. Thus, whether it is possible to establish connection with each of the wireless base station 18 and the free-space optical communication apparatus 19 varies according to the position of the wireless terminal 10. Therefore, it is possible to switch the connection destination at an appropriate timing, by causing the wireless terminal 10 to perform the switching process, in response to the wireless terminal 10 being located at such a position as to be capable of establishing connection both with the wireless base station 18 and with the free-space optical communication apparatus 19.

The wireless terminal 10 may determine that the wireless terminal 10 is located at such a position as to be capable of establishing both communication with a specific target, depending on the position of the wireless terminal 10 or depending on whether the wireless terminal and the specific target are successfully ready for connection in actuality. For example, in a case where the terminal control system 100 holds information that indicates predetermined connectable range(s) (coverage area(s)) of the wireless base station 18 and/or the free-space optical communication apparatus 19, the wireless terminal 10 may determine that the wireless terminal 10 is located at such a position as to be capable of establishing connection with the wireless base station 18 and/or with the free-space optical communication apparatus 19, in accordance with the wireless terminal 10 being within the predetermined range(s). For example, in a case where the terminal control system 100 does not hold the above information indicating the predetermined range(s), the wireless terminal 10 may determine that the wireless terminal 10 is located at such a position as to be capable of establishing connection with the wireless base station 18 and/or with the free-space optical communication apparatus 19, in accordance with the wireless terminal 10 being successfully ready for connection with the wireless base station 18 and/or with the free-space optical communication apparatus 19 in actuality.

In a case where the connection control means 101 is provided in the wireless terminal 10, the connection control means 101 may control the wireless terminal 10, to cause the wireless terminal 10 to perform the switching process. In a case where the connection control means 101 is provided in an apparatus which is not the wireless terminal 10, the connection control means 101 may, for example, transmit an instruction to the wireless terminal 10, to cause the wireless terminal 10 to perform the switching process. The method for transmitting the control signal is not particularly limited.

The wireless terminal 10 can perform the switching process in accordance with various standards. For example, the wireless terminal 10 may perform the switching process in accordance with the communication quality or communication rate of communication carried out through a connection destination to which the wireless terminal 10 is currently connected.

The weather information acquiring means 102 acquires weather information regarding an area in which the wireless terminal 10 is located. The weather information may be information indicating the most recent weather conditions, or may be information indicating a forecast of future weather conditions. Examples of the weather information encompass a value indicating the type of weather, a value indicating a rainfall amount, a value indicating a snowfall amount, a value indicating a visual range in fog, a value indicating the chance of rain or snow expected within a predetermined amount of time from the acquisition of weather information, a predicted value of a rainfall amount, a snowfall amount, or a visual range in fog expected within a predetermined amount of time from the acquisition of weather information, and the predicted course of a typhoon. Further, the weather information acquiring means 102 may continuously acquire (monitor) weather information, or may intermittently acquire weather information.

The switching stop means 103 may control the switching process in accordance with the weather information acquired by the weather information acquiring means 102. For example, the switching stop means 103 causes the wireless terminal 10 to stop, in accordance with the weather information, the switching process of switching the connection destination of the wireless terminal 10 from the wireless base station 18 to the free-space optical communication apparatus 19.

For example, in a case where the switching stop means 103 is provided in the wireless terminal 10, the switching stop means 103 may control the wireless terminal 10 to cause the wireless terminal 10 to perform the switching process. In a case where the switching stop means 103 is provided in an apparatus which is not the wireless terminal 10, the switching stop means 103 may, for example, transmit an instruction to the wireless terminal 10 to cause the wireless terminal 10 to perform the switching process. The method for transmitting the control signal is not particularly limited.

Free-space optical communication, in which light propagating through an outdoor space is mainly used, is susceptible to weather changes. For example, after first switching of the connection destination of the wireless terminal 10 to the free-space optical communication apparatus 19, the weather changes, and this weather change causes a decrease in the communication quality or communication rate of communication carried out through the free-space optical communication apparatus 19, and results in second switching of the connection destination of the wireless terminal 10 to the wireless base station 18. As can be seen from this example, depending on the weather, frequent switching of the connection destination could occur. In a case of the weather that causes a significant change in the communication quality or communication rate of communication carried out through the free-space optical communication apparatus 19, the switching stop means 103 causes the wireless terminal 10 to stop the switching process of switching the connection destination of the wireless terminal 10 from the wireless base station 18 to the free-space optical communication apparatus 19. This makes it possible to prevent the switching of the connection destination from occurring frequently. This example advantage is useful particularly in a case where the coverage area of wireless communication is small, as is true with 5G communication or the like, and the area of communication which is selected from wireless communication and free-space optical communication is therefore large.

### (Terminal Control Method)

The operation (terminal control method) of the terminal control system in accordance with the first example embodiment will be described with use of the drawings. FIG. 2 is a flowchart of an example operation of the terminal control system 100.

In step S201, the connection control means 101 causes the wireless terminal 10 to perform a switching process in response to the wireless terminal 10 being located at such a position as to be capable of establishing connection both with the wireless base station 18 and with the free-space optical communication apparatus 19. The switching process is a process to switch the connection destination of the wireless terminal 10 between the wireless base station 18 and the free-space optical communication apparatus 19.

In step S202, the weather information acquiring means 102 acquires weather information regarding an area in which the wireless terminal 10 is located. Note that steps S201 and S202 may carried out in the reverse order.

In step S203, the switching stop means 103 causes the wireless terminal 10 to stop the switching process of switching the connection destination of the wireless terminal 10 from the wireless base station 18 to the free-space optical communication apparatus 19, in accordance with the weather information acquired by the weather information acquiring means 102.

### (Terminal Control Apparatus)

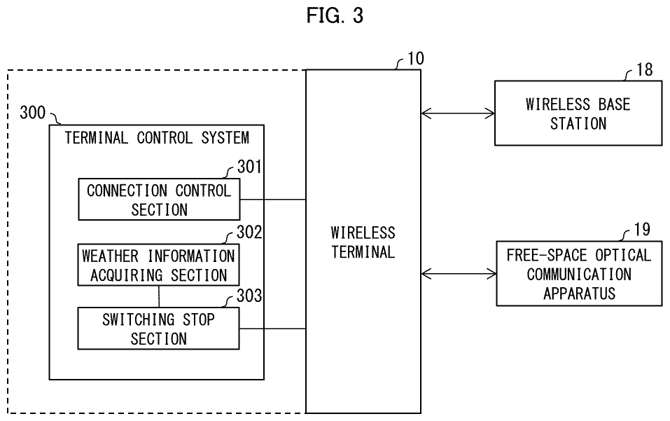

FIG. 3 is a block diagram of an example configuration of a terminal control apparatus 300 in accordance with the first example embodiment of the present invention. A connection control section 301 has a function equivalent to that of the connection control means 101, and causes the wireless terminal 10 to perform the switching process of switching the connection destination of the wireless terminal 10 between the wireless base station 18 and the free-space optical communication apparatus 19, in response to the wireless terminal 10 being located at such a position as to be capable of establishing connection both with the wireless base station 18 and with the free-space optical communication apparatus 19. A weather information acquiring section 302 has a function equivalent to that of the weather information acquiring means 102, and acquires weather information regarding an area in which the wireless terminal 10 is located. A switching stop section 303 has a function equivalent to that of the switching stop means 103, and causes the wireless terminal 10 to stop, in accordance with the weather information, the switching process of switching the connection destination of the wireless terminal 10 from the wireless base station 18 to the free-space optical communication apparatus 19.

The connection control section 301, the weather information acquiring section 302, and the switching stop section 303 may be computer equipment in which a processor executes a program stored in a memory so that a process is carried out. Each of the connection control section 301, the weather information acquiring section 302, and the switching stop section 303 may be partially or wholly included in the wireless terminal 10, or may be computer equipment that communicates with the wireless terminal 10. For example, the connection control section 301, the weather information acquiring section 302, and the switching stop section 303 may be provided by a single piece of computer equipment, or may be provided by a computer equipment group that operates through collaboration among pieces of computer equipment or by a server equipment group that operates through collaboration among pieces of server equipment. With the terminal control apparatus 300, it is possible to obtain an example advantage equivalent to the example advantage of the terminal control system 100.

### Second Example Embodiment

A terminal control system 400 in accordance with a second example embodiment is included in a wireless terminal 40. In the description of the second example embodiment, the same reference sign is assigned to a component that has the same function as the component described in the first example embodiment, and the description of such a component is omitted.

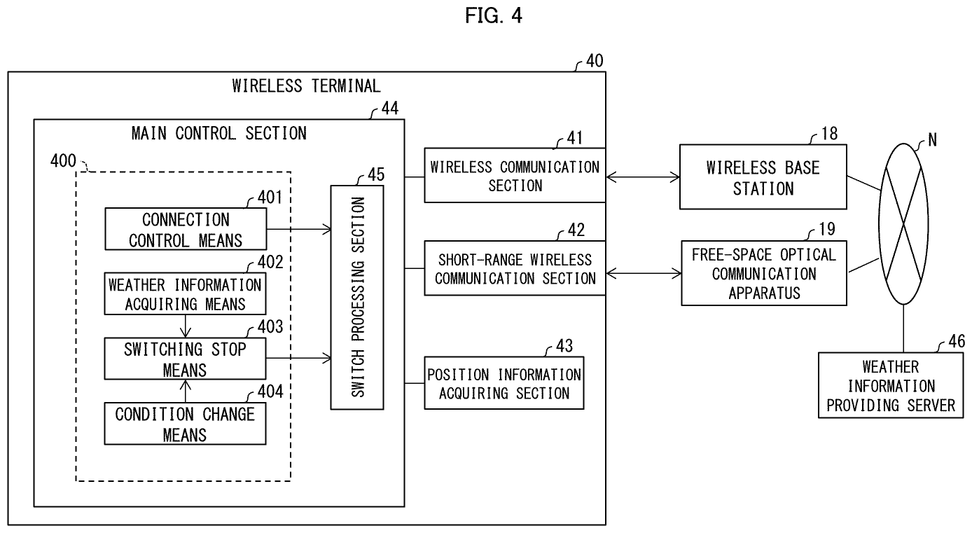

FIG. 4 is a block diagram of an example configuration of the terminal control system 400 in accordance with the second example embodiment of the present invention. As illustrated in FIG. 4, the wireless terminal 40 includes a wireless communication section 41, a short-range wireless communication section 42, a position information acquiring section 43, and a main control section 44. The main control section 44 includes a switch processing section 45 and the components of the terminal control system 400, which are a connection control means 401, a weather information acquiring means 402, a switching stop means 403, and a condition change means 404.

The wireless terminal 40 is capable of establishing connection with a wireless base station 18 and a free-space optical communication apparatus 19. The wireless base station 18 and the free-space optical communication apparatus 19 are capable of communicating with a weather information providing server 46 over a network N.

The weather information providing server 46 provides weather information regarding various areas. For example, when a query including position information is transmitted to the weather information providing server 46, the weather information providing server 46 provides weather information regarding an area indicated by the position information. Such a service, which is also referred to as Weather API, is provided by a number of companies.

The wireless communication section 41 establishes connection with the wireless base station 18 to carry out wireless communication. The scheme to carry out the wireless communication is not particularly limited, but may be a cellular communication scheme such as, for example, LTE or 5G. Further, the wireless communication section 41 is capable of acquiring the status of connection with the wireless base station 18 and the status of communication with the wireless base station 18. The wireless base station 18 is connected to the network N, and the wireless terminal 40 is capable of communicating with various servers and the like through the wireless base station 18. In other words, the wireless terminal 40 is capable of carrying out data communication via wireless communication. Note that the wireless terminal 40 may be connected to the network N through a wireless communication apparatus other than the wireless base station 18.

The short-range wireless communication section 42 establishes connection with the free-space optical communication apparatus 19 to carry out short-range wireless communication. The scheme to carry out the short-range wireless communication is not particularly limited, but may be a short-range wireless communication scheme such as, for example, the Wi-Fi or the Bluetooth. As an example, the wireless terminal 40 establishes connection with the free-space optical communication apparatus 19 via short-range wireless communication. Further, the short-range wireless communication section 42 is capable of acquiring the status of connection with the free-space optical communication apparatus 19 and the status of communication with the free-space optical communication apparatus 19. The free-space optical communication apparatus 19 is connected to the network N, and the wireless terminal 40 is capable of communicating with various servers and the like through the free-space optical communication apparatus 19. In other words, the wireless terminal 40 is capable of carrying out data communication via free-space optical communication.

The position information acquiring section 43 acquires position information regarding the wireless terminal 40. The position information acquiring section 43 has, for example, a GPS function, and is therefore capable of acquiring position information that indicates the position of the wireless terminal 40.

The switch processing section 45 performs a switching process of switching the connection destination of the wireless terminal 40 between the wireless base station 18 and the free-space optical communication apparatus 19. As an example, the switch processing section 45 may switch the connection destination of the wireless terminal 40 in accordance with the communication quality or communication rate of communication carried out through a connection destination to which the wireless terminal 40 is currently connected.

For example, in the switching process, the switch processing section 45 first acquires, from the wireless communication section 41 or the short-range wireless communication section 42, information on the communication quality or communication rate of communication carried out through a connection destination to which the wireless terminal 40 is currently connected. The switch processing section 45 may maintain the connection destination in a case where the communication quality or communication rate of the communication is greater than a predetermined threshold, and may change the connection destination in a case where the communication quality or communication rate of the communication is smaller than the predetermined threshold.

A switch processing section 34 may perform the switching process periodically, or may perform the switching process aperiodically. Further, the switch processing section 34 may continuously monitor the communication quality or communication rate of communication carried out through a connection destination to which the wireless terminal 40 is currently connected, to perform the switching process in response to the detection of a decrease in the communication quality or the communication rate.

In a case where the wireless terminal 40 is capable of establishing connection with the network N through a wireless communication apparatus other than the wireless base station 18, the switching process may be switching of the connection destination of the wireless terminal 40 between the free-space optical communication apparatus 19 and the wireless communication apparatus other than the wireless base station 18.

The connection control means 401 controls the switching process performed by the switch processing section 34. According to an example aspect, the connection control means 401 causes the switch processing section 34 to perform the switching process, in response to the wireless terminal 40 being located at such a position as to be capable of establishing connection both with the wireless base station 18 and with the free-space optical communication apparatus 19.

As an example, the connection control means 401 may determine that the wireless terminal 40 is located at such a position as to be capable of establishing connection both with the wireless base station 18 and with the free-space optical communication apparatus 19, depending on the status of connection between the wireless terminal 40 and the wireless base station 18 and the status of connection between the wireless terminal 40 and the free-space optical communication apparatus 19.

Specifically, the connection control means 401 acquires the status of connection between the wireless terminal 40 and the wireless base station 18 from the wireless communication section 41, and acquires the status of connection between the wireless terminal 40 and the free-space optical communication apparatus 19 from the short-range wireless communication section 42. In a case where the wireless terminal 40 is in a state of being capable of establishing connection both with the wireless base station 18 and with the free-space optical communication apparatus 19, the connection control means 401 may determine that the wireless terminal 40 is located at such a position as to be capable of establishing connection both with the wireless base station 18 and with the free-space optical communication apparatus 19.

As another example, the connection control means 401 may determine, depending on the position information regarding the wireless terminal 40, that the wireless terminal 40 is located at such a position as to be capable of establishing connection both with the wireless base station 18 and with the free-space optical communication apparatus 19.

The connection control means 401 is capable of acquiring map information that indicates the installation position of each wireless base station 18, the radio communication range of each wireless base station 18, the installation position of each free-space optical communication apparatus 19, and the radio communication range of each free-space optical communication apparatus 19. The connection control means 401 may refer to the map information to determine, in accordance with the position information regarding the wireless terminal 40, whether the wireless terminal 40 is located at such a position as to be capable of establishing connection both with the wireless base station 18 and with the free-space optical communication apparatus 19.

Subsequently, the connection control means 401 may cause the switch processing section 34 to perform the switching process, in response to determination that the wireless terminal 40 is located at such a position as to be capable of establishing connection both with the wireless base station 18 and with the free-space optical communication apparatus 19. In a case where it is not determined that the wireless terminal 40 is located at such a position as to be capable of establishing connection both with the wireless base station 18 and with the free-space optical communication apparatus 19, the connection control means 401 may cause the switch processing section 34 to end the switching process.

The weather information acquiring means 402 acquires weather information regarding an area in which the wireless terminal 40 is located. As an example, the weather information acquiring means 402 may acquire weather information in accordance with the position information regarding the wireless terminal 40. For example, the weather information acquiring means 402 may transmit the position information, acquired by the position information acquiring section 43, regarding the wireless terminal 40 to the weather information providing server 46 through the wireless communication section 41 or the short-range wireless communication section 42, to acquire, from the weather information providing server 46, weather information regarding an area in which the wireless terminal 40 is located. Note that, the weather information acquiring means 402 may continuously acquire (monitor) weather information, or may intermittently acquire weather information.

The switching stop means 403 controls the switch processing section 45 in accordance with the weather information. Specifically, the switching stop means 403 causes the wireless terminal 40 to stop, in accordance with the weather information, the switching process of switching the connection destination of the wireless terminal 40 from the wireless base station 18 to the free-space optical communication apparatus 19.

For example, in a case where the weather information meets a predetermined condition, the switching stop means 403 may control the switch processing section 45 such that the switch processing section 45 causes the wireless terminal 40 to stop the switching process of switching the connection destination of the wireless terminal 40 from the wireless base station 18 to the free-space optical communication apparatus 19. With this control, a switching process of switching the connection destination of the wireless terminal 40 from the free-space optical communication apparatus 19 to the wireless base station 18 is performed, but a switching process of switching from the wireless base station 18 to the free-space optical communication apparatus 19 is not performed. This prevents the switching of the connection destination from occurring frequently, and therefore makes it possible to prevent a user from experiencing discomfort.

The weather information acquired by the weather information acquiring means 402 and referred to by the switching stop means 403 may be information indicating the most recent weather conditions, or may be information indicating a forecast of future weather conditions. Examples of the weather information encompass a value indicating the type of weather, a value indicating a rainfall amount, a value indicating a snowfall amount, a value indicating a visual range, a value indicating the chance of rain or snow expected within a predetermined amount of time from the acquisition of weather information, a predicted value of a rainfall amount, a snowfall amount, or a visual range in fog expected within a predetermined amount of time from the acquisition of weather information, and the predicted course of a typhoon. These kinds of weather information relate to the weather that significantly affects free-space optical communication, such as rain, snow, or fog. The switching stop means 403 makes the determination in accordance with these kinds of weather information, to make it possible to prevent the switching of the connection destination from occurring frequently due to the weather.

According to an example embodiment, the switching stop means 403 may determine, in accordance with the weather information meeting a predetermined condition, that the switching process of switching the connection destination of the wireless terminal 40 from the wireless base station 18 to the free-space optical communication apparatus 19 should be stopped. For example, the switching stop means 403 may compare a value indicating weather information (e.g., a value of at least one selected from the group consisting of a rainfall amount, a snowfall amount, and a visual range) with a predetermined threshold, to determine whether to cause the wireless terminal 40 to stop the switching process of switching the connection destination of the wireless terminal 40 from the wireless base station 18 to the free-space optical communication apparatus 19.

The predetermined condition and the predetermined threshold used by the switching stop means 403 for the determination may be changeable. According to an example embodiment, the condition change means 404 changes, according to the position information regarding the wireless terminal 40, the predetermined condition or the predetermined threshold used by the switching stop means 403 for the determination. When the wireless terminal 40 is closer to the wireless base station 18, the communication quality or communication rate of communication between the wireless terminal 40 and the wireless base station 18 tends to be better. This reduces the need for communication carried out through the free-space optical communication apparatus 19. In contrast, in a case where the wireless terminal 40 is located in the peripheral part of the coverage area of the wireless base station 18, wireless communication is less likely to be established, and free-space optical communication is preferably put before wireless communication. By the condition change means 404 changing the above predetermined condition or predetermined threshold in accordance with the position information regarding the wireless terminal 40, it is possible for the terminal control system 400 to consider the wireless communication environment of the wireless terminal 40 to determine whether to cause the wireless terminal 40 to stop the switching process of switching the connection destination of the wireless terminal 40 from the wireless base station 18 to the free-space optical communication apparatus 19. This makes it possible to select communication the quality of which is likely to be higher, in accordance with the position information regarding the wireless terminal 40 and the weather information.

As an example, the condition change means 404 may calculate the distance between the wireless terminal 40 and the wireless base station 18 in accordance with the position information regarding the wireless terminal 40, and set the predetermined condition or the predetermined threshold such that the condition for causing the wireless terminal 40 to stop the switching process is less strict when the wireless terminal 40 is closer to the wireless base station 18. As another example, in a case where, judging from the position information regarding the wireless terminal 40, the wireless terminal 40 is located in the peripheral part of the coverage area of the wireless base station 18, the condition change means 404 may set the predetermined condition or the predetermined threshold such that the condition for causing the wireless terminal 40 to stop the switching process is strict. Further, in a case where the weather information meets the condition set by the condition change means 404, the switching stop means 403 may cause the wireless terminal 40 to stop the switching process of switching the connection destination of the wireless terminal 40 from the wireless base station 18 to the free-space optical communication apparatus 19.

The predetermined condition and the predetermined threshold used by the switching stop means 403 for the determination may be changeable as described above. Optionally, the predetermined condition and the predetermined threshold are not changeable. In a case where the predetermined condition and the predetermined threshold used by the switching stop means 403 for the determination are not changeable, the condition change means 404 may be omitted.

In the above description, the second example embodiment is the terminal control system 400. The second example embodiment may be a terminal control apparatus which is a single apparatus into which the terminal control system 400 in accordance with the second example embodiment is incorporated. A terminal control method in accordance with the second example embodiment may be the terminal control method in accordance with the first example embodiment in which the operation of the terminal control system 400 in accordance with the second example embodiment replaces the operation of the terminal control system 100 in accordance with the first example embodiment.

### Third Example Embodiment

The components of a terminal control system 500 in accordance with a third example embodiment are dispersedly located in a wireless terminal 50 and a server 57. In the description of the third example embodiment, the same reference sign is assigned to a component that has the same function as the component described in the first or second example embodiment, and the description of such a component is omitted.

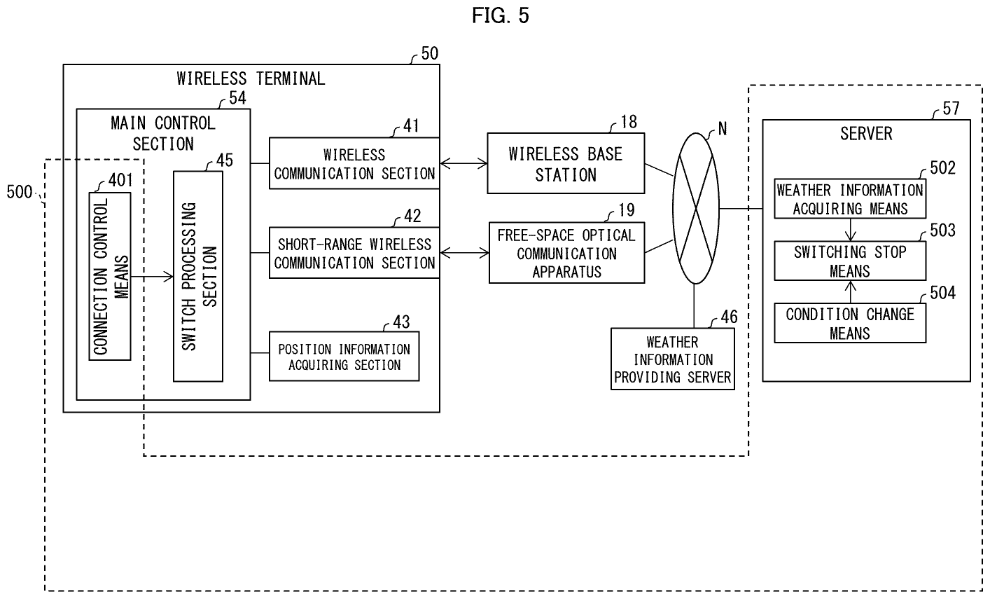

FIG. 5 is a block diagram of an example configuration of the terminal control system 500 in accordance with the third example embodiment of the present invention. As illustrated in FIG. 5, the wireless terminal 50 includes a wireless communication section 41, a short-range wireless communication section 42, a position information acquiring section 43, and a main control section 54. The main control section 54 includes a switch processing section 45 and a connection control means 401. The server 57 includes a weather information acquiring means 502, a switching stop means 503, and a condition change means 504. The terminal control system 500 includes a connection control means 401, a weather information acquiring means 502, a switching stop means 503, and a condition change means 504.

The wireless terminal 50 is capable of establishing connection with a wireless base station 18 and with a free-space optical communication apparatus 19. The wireless base station 18 and the free-space optical communication apparatus 19 are capable of communicating with a weather information providing server 46 and the server 57 over a network N. Accordingly, the wireless terminal 50 is capable of communicating with the server 57 through the wireless base station 18 or the free-space optical communication apparatus 19.

The weather information acquiring means 502 acquires weather information regarding an area in which the wireless terminal 50 is located. As an example, the weather information acquiring means 502 may acquire weather information in accordance with the position information regarding the wireless terminal 50. For example, the weather information acquiring means 502 may receive the position information regarding the wireless terminal 50 from the wireless terminal 50 through the wireless base station 18, the free-space optical communication apparatus 19 or any other communication path. The weather information acquiring means 502 may then transmit the position information regarding the wireless terminal 50 to the weather information providing server 46 over the network N, and acquire, from the weather information providing server 46, weather information regarding an area in which the wireless terminal 50 is located. The weather information acquired by the weather information acquiring means 502 is the same as that of the second example embodiment. Note that, the weather information acquiring means 502 may continuously acquire (monitor) weather information, or may intermittently acquire weather information.

The switching stop means 503 causes the wireless terminal 50 to stop, in accordance with the weather information, a switching process of switching the connection destination of the wireless terminal 50 from the wireless base station 18 to the free-space optical communication apparatus 19. For example, in a case where the weather information meets a predetermined condition, the switching stop means 503 transmits, to the wireless terminal 50 through the wireless base station 18, the free-space optical communication apparatus 19, or any other communication path, an instruction to cause the wireless terminal 50 to stop the switching process of switching the connection destination of the wireless terminal 50 from the wireless base station 18 to the free-space optical communication apparatus 19. When receiving the instruction, the main control section 54 of the wireless terminal 50 causes the switch processing section 45 to stop the switching process of switching the connection destination of the wireless terminal 50 from the wireless base station 18 to the free-space optical communication apparatus 19. This prevents the switching of the connection destination from occurring frequently, and therefore makes it possible to prevent a user from experiencing discomfort, as in the second example embodiment.

Like the condition change means 404 in the second example embodiment, the condition change means 504 may change, according to the position information regarding the wireless terminal 50, the predetermined condition or a predetermined threshold used by the switching stop means 503 for the determination.

### (Variation)

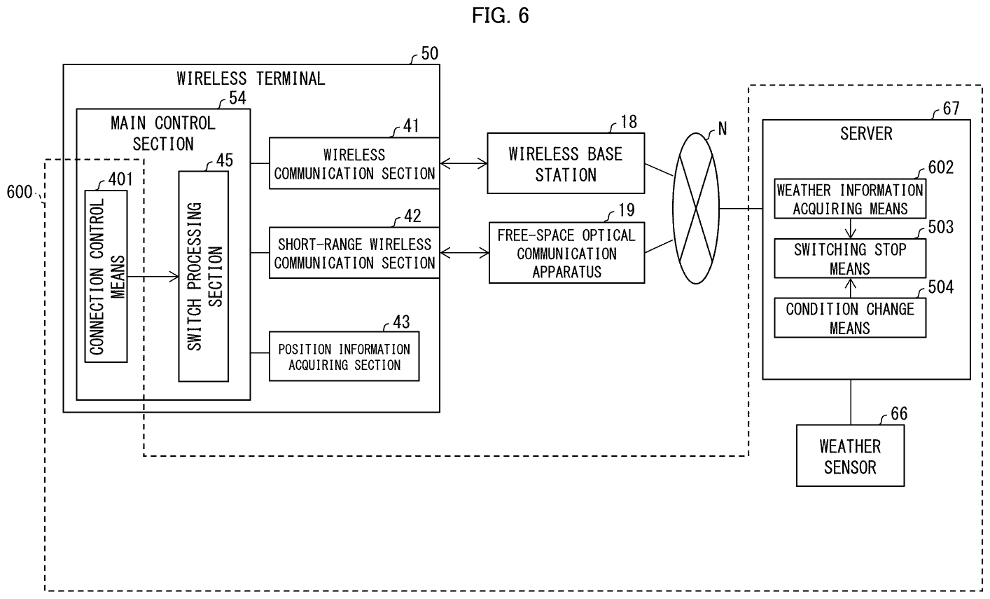

The weather information may be acquired from a weather sensor 66 instead of the weather information providing server 46. FIG. 6 is a block diagram of an example configuration of a terminal control system 600 in accordance with a variation of the third example embodiment of the present invention. As illustrated in FIG. 6, a server 67 includes a weather information acquiring means 602 and the switching stop means 503. To the server 67, the weather sensor 66 is connected. The terminal control system 600 includes the connection control means 401, the weather information acquiring means 602, and the switching stop means 503.

The weather sensor 66 measures weather information. Examples of the weather sensor 66 may encompass, but not limited to, a sensor that measures at least one selected from the group consisting of a rainfall amount, a snowfall amount, and a visual range.

As an example, the weather sensor 66 may be disposed in the radio communication range (service area) of the wireless base station 18. With this disposition, the weather sensor 66 can acquire weather information regarding an area corresponding to the radio communication range of the wireless base station 18. The weather information regarding an area corresponding to the radio communication range of the wireless base station 18 can be used as the weather information regarding an area in which the wireless terminal 50 is located, the wireless terminal 50 being located at such a position as to be capable of establishing connection with the wireless base station 18 is located.

Thus, the weather information acquiring means 602 can acquire the weather information regarding an area in which the wireless terminal 50 is located, by acquiring weather information from the weather sensor 66. Note that the weather sensor 66 may be provided for each wireless base station 18, and the weather information acquiring means 602 may receive, from the wireless terminal 50 through the wireless base station 18, the free-space optical communication apparatus 19, or any other communication path, identification information regarding the wireless base station 18 with which the wireless terminal 50 is capable of establishing connection. The weather information acquiring means 602 can then acquire weather information regarding an area in which the wireless terminal 50 is located, by acquiring weather information from the weather sensor 66 disposed in the radio communication range of the wireless base station 18 that corresponds to the identification information received.

The weather information acquiring means 602 may acquire weather information regarding an area in which the wireless terminal 50 is located, by acquiring, in accordance with position information regarding the wireless terminal 50, weather information from the weather sensor 66 that corresponds to the position information.

A configuration described in the present variation is that the weather information acquiring means 602 acquires weather information from the weather sensor 66 in the third example embodiment. However, the configuration in which the weather information acquiring means acquires weather information from the weather sensor may be applied to the other example embodiments.

A configuration described above is that the weather information acquiring means 502, the switching stop means 503, and the condition change means 504 are included in the server 57. However, one or more of these means may be included in the wireless terminal 50, as in the second example embodiment. In that case, one or more of the weather information acquiring means 502, the switching stop means 503, and the condition change means 504 may operate in the same manner as do the weather information acquiring means 402, the switching stop means 403, and the condition change means 404 described in the second example embodiment.

In the description above, the third example embodiment is the terminal control system 500 or the terminal control system 600. The third example embodiment may be a terminal control apparatus which is a single apparatus into which the terminal control system 500 or the terminal control system 600 is incorporated. A terminal control method in accordance with the third example embodiment may be the terminal control method in accordance with the first example embodiment in which the operation of the terminal control system 500 or the terminal control system 600 of the third example embodiment replaces the operation of the terminal control system 100 in accordance with the first example embodiment.

### Fourth Example Embodiment

A terminal control system 700 in accordance with a fourth example embodiment is included in a server 77. In the description of the fourth example embodiment, the same reference sign is assigned to a component that has the same function as the component described in the first, second, or third example embodiment, and the description of such a component is omitted.

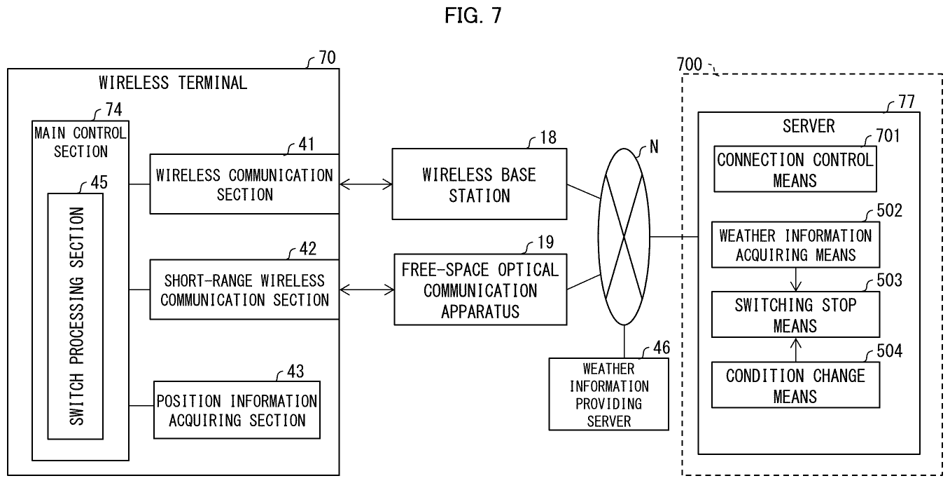

FIG. 7 is a block diagram of an example configuration of the terminal control system 700 in accordance with the fourth example embodiment of the present invention. As illustrated in FIG. 7, a wireless terminal 70 includes a wireless communication section 41, a short-range wireless communication section 42, a position information acquiring section 43, and a main control section 74. The main control section 74 includes a switch processing section 45. The server 77 includes a connection control means 701, a weather information acquiring means 502, a switching stop means 503, and a condition change means 504. The terminal control system 700 includes a connection control means 701, a weather information acquiring means 502, a switching stop means 503, and a condition change means 504.

The wireless terminal 70 is capable of establishing connection with a wireless base station 18 and a free-space optical communication apparatus 19. The wireless base station 18 and the free-space optical communication apparatus 19 are capable of communicating with a weather information providing server 46 and the server 77 over a network N. Accordingly, the wireless terminal 70 is capable of communicating with the server 77 through the wireless base station 18 and the free-space optical communication apparatus 19.

The connection control means 701 causes the switch processing section 45 to perform a switching process, in response to the wireless terminal 70 being located at such a position as to be capable of establishing connection both with the wireless base station 18 and with the free-space optical communication apparatus 19. For example, in a case of determination that the wireless terminal 70 is located such a position as to be capable of establishing connection both with the wireless base station 18 and with the free-space optical communication apparatus 19, the connection control means 701 transmits, to the wireless terminal 70 through the wireless base station 18, the free-space optical communication apparatus 19, or any other communication path, an instruction to cause the wireless terminal 70 to perform the switching process. When receiving the instruction, the main control section 74 of the wireless terminal 70 causes the switch processing section 45 to perform the switching process.

As an example, the connection control means 701 may determine, depending on the position information regarding the wireless terminal 70, that the wireless terminal 70 is located at such a position as to be capable of establishing connection both with the wireless base station 18 and with the free-space optical communication apparatus 19.

Map information is inputted in advance in the server 77, or the server 77 has an access to the map information, the map information indicating the installation position of each wireless base station 18, the radio communication range of each wireless base station 18, the installation position of each free-space optical communication apparatus 19, and the radio communication range of each free-space optical communication apparatus 19. The connection control means 701 may refer to the map information to determine, in accordance with the position information regarding the wireless terminal 70, whether the wireless terminal 70 is located at such a position as to be capable of establishing connection both with the wireless base station 18 and with the free-space optical communication apparatus 19.

Note that, as described above, the inventors of the present invention are considering using free-space optical communication technique to complement wireless communication such as local 5G communication, on the basis of their unique idea. Specifically, by disposing the free-space optical communication apparatus 19 in the peripheral part of the radio communication range of each wireless base station 18, it is possible to provide a preferred communication environment. Thus, with the assumption of such a disposition, the connection control means 701 may determine, depending on whether the wireless terminal 70 is located in the peripheral part of the radio communication range of the wireless base station 18, that the wireless terminal 70 is located at such a position as to be capable of establishing connection both with the wireless base station 18 and with the free-space optical communication apparatus 19.

As another example, the connection control means 701 may acquire, from the wireless terminal 70, the status of connection between the wireless terminal 70 and the wireless base station 18 and the status of connection between the wireless terminal 70 and the free-space optical communication apparatus 19 to determine, depending on the statuses acquired, that the wireless terminal 70 is located at such a position as to be capable of establishing connection both with the wireless base station 18 and with the free-space optical communication apparatus 19, as in the second example embodiment.

A configuration described above is that the connection control means 701, the weather information acquiring means 502, the switching stop means 503, and the condition change means 504 are included in the server 77. However, one or more of these means may be included in the wireless terminal 70, as in the second example embodiment. In that case, one or more of the connection control means 701, the weather information acquiring means 502, the switching stop means 503, and the condition change means 504 may operate in the same manner as do the connection control means 401, the weather information acquiring means 402, the switching stop means 403, and the condition change means 404 described in the second example embodiment.

In the description above, the fourth example embodiment is the terminal control system 700. The fourth example embodiment may be a terminal control apparatus which is a single apparatus into which the terminal control system 700 in accordance with the fourth example embodiment is incorporated. A terminal control method in accordance with the fourth example embodiment may be the terminal control method in accordance with the first example embodiment in which the operation of the terminal control system 700 in accordance with the fourth example embodiment replaces the operation of the terminal control system 100 in accordance with the first example embodiment.

A configuration described in the fourth example embodiment is that the connection control means 701 provided in the server 77 determines, depending on the position information regarding the wireless terminal 70, that the wireless terminal 70 is located at such a position as to be capable of establishing connection both with the wireless base station 18 and with the free-space optical communication apparatus 19. The configuration in which the connection control means determines, depending on the position information regarding the wireless terminal, that the wireless terminal is located at such a position as to be capable of establishing connection both with the wireless base station and with the free-space optical communication apparatus may be applied to the other example embodiments.

The present disclosure is not limited to the example embodiments above, but can be altered by a skilled person in the art in various ways. The present disclosure also encompasses, in its technical scope, any example embodiment derived by combining configurations, operations, and processes disclosed in differing example embodiments.

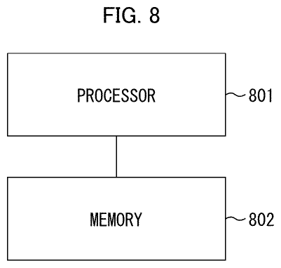

Each of the components in accordance with the first to fourth example embodiments may be configured via a single piece of hardware. Each of the components in accordance with the first to fourth example embodiments may be configured via a single piece of software. Each of the components in accordance with the first to fourth example embodiments may be configured via a plurality of pieces of hardware. Each of the components in accordance with the first to fourth example embodiments may be configured via a plurality of pieces of software. The first to fourth example embodiments may be provided by a combination of hardware and software. Each of the functions in accordance with the first to fourth example embodiments may be implemented with use of the cloud. Each apparatus, each function, and each process may be provided with use of a computer including a processor 801 and a memory 802 as illustrated in FIG. 8. For example, a program for carrying out the terminal control methods described in the first to fourth example embodiments may be stored in the memory 802, and the processor 801 may retrieve and execute the program stored in the memory 802, so that the functions described in the first to fourth example embodiments may be implemented.

The program contains a set of instructions to, when the program is loaded into the computer, causes the computer to carry out one or more of the functions described in the first to fourth example embodiments. The program is stored in the memory 802. Examples of the processor 801 can encompass a central processing unit (CPU). Examples of the memory 802 can encompass a read only memory (ROM), a random access memory (RAM), a flash memory, and a solid state drive (SSD).

The present disclosure is not limited to the example embodiments above. That is, the present invention can apply, within the scope of the present disclosure, various example aspects that could be understood by a person skilled in the art. All or some of the example embodiments above can also be described as below. Note, however, that the present invention is not limited to the following example aspects.

### Supplementary Note 1

A terminal control system including: a connection control means for causing a wireless terminal to perform a switching process of switching a connection destination of the wireless terminal between a wireless base station and a free-space optical communication apparatus, in response to the wireless terminal being located at such a position as to be capable of establishing connection both with the wireless base station and with the free-space optical communication apparatus;
a weather information acquisition means for acquiring weather information regarding an area in which the wireless terminal is located; and
a switching stop means for causing the wireless terminal to stop, in accordance with the weather information, the switching process of switching the connection destination of the wireless terminal from the wireless base station to the free-space optical communication apparatus.

### Supplementary Note 2

The terminal control system described in supplementary note 1, in which: the switching stop means is configured to cause the wireless terminal to stop the switching process of switching the connection destination of the wireless terminal from the wireless base station to the free-space optical communication apparatus, in accordance with the weather information meeting a condition; and
the terminal control system further includes a condition change means for changing the condition according to position information regarding the wireless terminal.

### Supplementary Note 3

The terminal control system described in supplementary note 1, in which the wireless terminal is configured to establish connection with the free-space optical communication apparatus via short-range wireless communication.

### Supplementary note 4

The terminal control system described in supplementary note 1, in which in the switching process, the wireless terminal is configured to switch the connection destination in accordance with a communication quality or communication rate of communication carried out through the connection destination.

### Supplementary Note 5

The terminal control system described in any one of supplementary notes 1 to 4, in which the connection control means is configured to determine, depending on a status of connection between the wireless terminal and the wireless base station and a status of connection between the wireless terminal and the free-space optical communication apparatus, that the wireless terminal is located at such a position as to be capable of establishing connection both with the wireless base station and with the free-space optical communication apparatus.

### Supplementary Note 6

The terminal control system described in any one of supplementary notes 1 to 4, in which the connection control means is configured to determine, depending on position information regarding the wireless terminal, that the wireless terminal is located at such a position as to be capable of establishing connection both with the wireless base station and with the free-space optical communication apparatus.

### Supplementary Note 7

The terminal control system described in supplementary note 6, in which the connection control means is configured to determine, depending on whether the wireless terminal is located in a peripheral part of a radio communication range of the wireless base station, that the wireless terminal is located at such a position as to be capable of establishing connection both with the wireless base station and with the free-space optical communication apparatus.

### Supplementary Note 8

The terminal control system described in supplementary note 1, in which the weather information acquiring means is configured to acquire the weather information in accordance with position information regarding the wireless terminal.

### Supplementary Note 9

The terminal control system described in supplementary note 1, in which the weather information is at least one selected from the group consisting of a rainfall amount, a snowfall amount, and a visual range.

### Supplementary Note 10

A terminal control apparatus including: a connection control section for causing a wireless terminal to perform a switching process of switching a connection destination of the wireless terminal between a wireless base station and a free-space optical communication apparatus, in response to the wireless terminal being located at such a position as to be capable of establishing connection both with the wireless base station and with the free-space optical communication apparatus;
a weather information acquiring section for acquiring weather information regarding an area in which the wireless terminal is located; and
a switching stop section for causing the wireless terminal to stop, in accordance with the weather information, the switching process of switching the connection destination of the wireless terminal from the wireless base station to the free-space optical communication apparatus.

### Supplementary Note 11

The terminal control apparatus described in supplementary note 10, in which: the switching stop section is configured to cause the wireless terminal to stop the switching process of switching the connection destination of the wireless terminal from the wireless base station to the free-space optical communication apparatus, in accordance with the weather information meeting a condition; and
the terminal control apparatus further includes a condition changing section for changing the condition according to position information regarding the wireless terminal.

### Supplementary Note 12

The terminal control apparatus described in supplementary note 10, in which the wireless terminal is configured to establish connection with the free-space optical communication apparatus via short-range wireless communication.

### Supplementary Note 13

The terminal control apparatus described in supplementary note 10, in which in the switching process, the wireless terminal is configured to switch the connection destination in accordance with a communication quality or communication rate of communication carried out through the connection destination.

### Supplementary Note 14

The terminal control apparatus described in any one of supplementary notes 10 to 13, in which the connection control section is configured to determine, depending on a status of connection between the wireless terminal and the wireless base station and a status of connection between the wireless terminal and the free-space optical communication apparatus, that the wireless terminal is located at such a position as to be capable of establishing connection both with the wireless base station and with the free-space optical communication apparatus.

### Supplementary Note 15

The terminal control apparatus described in any one of supplementary notes 10 to 13, in which the connection control section is configured to determine, depending on position information regarding the wireless terminal, that the wireless terminal is located at such a position as to be capable of establishing connection both with the wireless base station and with the free-space optical communication apparatus.

### Supplementary Note 16

The terminal control apparatus described in supplementary note 15, in which the connection control section is configured to determine, depending on whether the wireless terminal is located in a peripheral part of a radio communication range of the wireless base station, that the wireless terminal is located at such a position as to be capable of establishing connection both with the wireless base station and with the free-space optical communication apparatus.

### Supplementary Note 17

The terminal control apparatus described in supplementary note 10, in which the weather information acquiring section is configured to acquire the weather information in accordance with position information regarding the wireless terminal.

### Supplementary Note 18

The terminal control apparatus described in supplementary note 10, in which the weather information is at least one selected from the group consisting of a rainfall amount, a snowfall amount, and a visual range.

### Supplementary Note 19

A terminal control method including: causing a wireless terminal to perform a switching process of switching a connection destination of the wireless terminal between a wireless base station and a free-space optical communication apparatus, in response to the wireless terminal being located at such a position as to be capable of establishing connection both with the wireless base station and with the free-space optical communication apparatus;
acquiring weather information regarding an area in which the wireless terminal is located; and
causing the wireless terminal to stop, in accordance with the weather information, the switching process of switching the connection destination of the wireless terminal from the wireless base station to the free-space optical communication apparatus.

### Supplementary Note 20

The terminal control method described in supplementary note 19, in which in the causing the wireless terminal to stop the switching process, the switching process of switching the connection destination of the wireless terminal from the wireless base station to the free-space optical communication apparatus is stopped in accordance with the weather information meeting a condition; and
the method further includes changing the condition according to position information regarding the wireless terminal.

### Supplementary Note 21

The terminal control method described in supplementary note 19, in which the wireless terminal is configured to establish connection with the free-space optical communication apparatus via short-range wireless communication.

### Supplementary Note 22

The terminal control method described in supplementary note 19, in which in the switching process, the wireless terminal is configured to switch the connection destination in accordance with a communication quality or communication rate of communication carried out through the connection destination.

### Supplementary Note 23

The terminal control method described in any one of supplementary notes 19 to 22, in which in the causing the wireless terminal to perform the switching process, it is determined, depending on a status of connection between the wireless terminal and the wireless base station and a status of connection between the wireless terminal and the free-space optical communication apparatus, that the wireless terminal is located at such a position as to be capable of establishing connection both with the wireless base station and with the free-space optical communication apparatus.

### Supplementary Note 24

The terminal control method described in any one of supplementary notes 19 to 22, in which in the causing the wireless terminal to perform the switching process, it is determined, depending on position information regarding the wireless terminal, that the wireless terminal is located at such a position as to be capable of establishing connection both with the wireless base station and with the free-space optical communication apparatus.

### Supplementary Note 25

The terminal control method described in supplementary note 24, in which in the causing the wireless terminal to perform the switching process, it is determined, depending on whether the wireless terminal is located in a peripheral part of a radio communication range of the wireless base station, that the wireless terminal is located at such a position as to be capable of establishing connection both with the wireless base station and with the free-space optical communication apparatus.

### Supplementary Note 26

The terminal control method described in supplementary note 19, in which in the acquiring, the weather information is acquired in accordance with position information regarding the wireless terminal.

### Supplementary Note 27

The terminal control method described in supplementary note 19, in which the weather information is at least one selected from the group consisting of a rainfall amount, a snowfall amount, and a visual range.

### REFERENCE SIGNS LIST

10, 40, 50, 70: Wireless terminal
18: Wireless base station
19: Free-space optical communication apparatus
41: Wireless communication section
42: Short-range wireless communication section
43: Position information acquiring section
44, 54, 74: Main control section
45: Switch processing section
46: Weather information providing server
57: Server
66: Weather sensor
100, 400, 500, 600, 700: Terminal control system
101, 401, 701: Connection control means
102, 402, 502, 602: Weather information acquiring means
103, 403, 503: Switching stop means
404, 504: Condition change means
300: Terminal control apparatus
301: Connection control section
302: Weather information acquiring section
303: Switching stop section

1. A terminal control system comprising
at least one processor,
the at least one processor carrying out:
a connection control process of causing a wireless terminal to perform a switching process of switching a connection destination of the wireless terminal between a wireless base station and a free-space optical communication apparatus, in response to the wireless terminal being located at such a position as to be capable of establishing connection both with the wireless base station and with the free-space optical communication apparatus;
a weather information acquisition process of acquiring weather information regarding an area in which the wireless terminal is located; and
a switching stop process of causing the wireless terminal to stop, in accordance with the weather information, the switching process of switching the connection destination of the wireless terminal from the wireless base station to the free-space optical communication apparatus.

2. The terminal control system according to claim 1, wherein:
in the switching stop process, the at least one processor causes the wireless terminal to stop the switching process of switching the connection destination of the wireless terminal from the wireless base station to the free-space optical communication apparatus, in accordance with the weather information meeting a condition; and
the at least one processor further carries out a condition change process of changing the condition according to position information regarding the wireless terminal.

3. The terminal control system according to claim 1, wherein
the wireless terminal is configured to establish connection with the free-space optical communication apparatus via short-range wireless communication.

4. The terminal control system according to claim 1, wherein
in the switching process, the wireless terminal is configured to switch the connection destination in accordance with a communication quality or communication rate of communication carried out through the connection destination.

5. The terminal control system according to claim 1, wherein
in the connection control process, the at least one processor determines, depending on a status of connection between the wireless terminal and the wireless base station and a status of connection between the wireless terminal and the free-space optical communication apparatus, that the wireless terminal is located at such a position as to be capable of establishing connection both with the wireless base station and with the free-space optical communication apparatus.

6. The terminal control system according to claim 1, wherein
in the connection control process, the at least one processor determines, depending on position information regarding the wireless terminal, that the wireless terminal is located at such a position as to be capable of establishing connection both with the wireless base station and with the free-space optical communication apparatus.

7. The terminal control system according to claim 6, wherein
in the connection control process, the at least one processor determines, depending on whether the wireless terminal is located in a peripheral part of a radio communication range of the wireless base station, that the wireless terminal is located at such a position as to be capable of establishing connection both with the wireless base station and with the free-space optical communication apparatus.

8. The terminal control system according to claim 1, wherein
in the weather information acquisition process, the at least one processor acquires the weather information in accordance with position information regarding the wireless terminal.

9. A terminal control apparatus comprising
at least one processor,
the at least one processor carrying out:
a connection control process of causing a wireless terminal to perform a switching process of switching a connection destination of the wireless terminal between a wireless base station and a free-space optical communication apparatus, in response to the wireless terminal being located at such a position as to be capable of establishing connection both with the wireless base station and with the free-space optical communication apparatus;
a weather information acquisition process of acquiring weather information regarding an area in which the wireless terminal is located; and
a switching stop process of causing the wireless terminal to stop, in accordance with the weather information, the switching process of switching the connection destination of the wireless terminal from the wireless base station to the free-space optical communication apparatus.

10. The terminal control apparatus according to claim 9, wherein:
in the switching stop process, the at least one processor causes the wireless terminal to stop the switching process of switching the connection destination of the wireless terminal from the wireless base station to the free-space optical communication apparatus, in accordance with the weather information meeting a condition; and
the at least one processor further carries out a condition change process of changing the condition according to position information regarding the wireless terminal.

11. The terminal control apparatus according to claim 9, wherein
the wireless terminal is configured to establish connection with the free-space optical communication apparatus via short-range wireless communication.

12. The terminal control apparatus according to claim 9, wherein
in the switching process, the wireless terminal is configured to switch the connection destination in accordance with a communication quality or communication rate of communication carried out through the connection destination.

13. The terminal control apparatus according to claim 9, wherein
in the connection control process, the at least one processor determines, depending on a status of connection between the wireless terminal and the wireless base station and a status of connection between the wireless terminal and the free-space optical communication apparatus, that the wireless terminal is located at such a position as to be capable of establishing connection both with the wireless base station and with the free-space optical communication apparatus.

14. The terminal control apparatus according to claim 9, wherein
in the connection control process, the at least one processor determines, depending on position information regarding the wireless terminal, that the wireless terminal is located at such a position as to be capable of establishing connection both with the wireless base station and with the free-space optical communication apparatus.

15. A terminal control method comprising:
causing a wireless terminal to perform a switching process of switching a connection destination of the wireless terminal between a wireless base station and a free-space optical communication apparatus, in response to the wireless terminal being located at such a position as to be capable of establishing connection both with the wireless base station and with the free-space optical communication apparatus;
acquiring weather information regarding an area in which the wireless terminal is located; and
causing the wireless terminal to stop, in accordance with the weather information, the switching process of switching the connection destination of the wireless terminal from the wireless base station to the free-space optical communication apparatus.

16. The terminal control method according to claim 15, wherein:
in the causing the wireless terminal to stop the switching process, the switching process of switching the connection destination of the wireless terminal from the wireless base station to the free-space optical communication apparatus is stopped in accordance with the weather information meeting a condition; and
the method further comprises changing the condition according to position information regarding the wireless terminal.

17. The terminal control method according to claim 15, wherein
the wireless terminal is configured to establish connection with the free-space optical communication apparatus via short-range wireless communication.

18. The terminal control method according to claim 15, wherein
in the switching process, the wireless terminal is configured to switch the connection destination in accordance with a communication quality or communication rate of communication carried out through the connection destination.

19. The terminal control method according to claim 15, wherein, in the causing the wireless terminal to perform the switching process, it is determined, depending on a status of connection between the wireless terminal and the wireless base station and a status of connection between the wireless terminal and the free-space optical communication apparatus, that the wireless terminal is located at such a position as to be capable of establishing connection both with the wireless base station and with the free-space optical communication apparatus.

20. The terminal control method according to claim 15, wherein
in the causing the wireless terminal to perform the switching process, it is determined, depending on position information regarding the wireless terminal, that the wireless terminal is located at such a position as to be capable of establishing connection both with the wireless base station and with the free-space optical communication apparatus.
